(19) United States
(12) Patent Application Publication
(10) Pub. No.: US 2023/0409322 A1
(43) Pub. Date: Dec. 21, 2023

(54) PROCESSOR CIRCUITRY TO DETERMINE AN ENABLEMENT STATE FOR A CONSTRAINT ON MULTIPLE THREADS OF EXECUTION

(71) Applicant: Intel Corporation, Santa Clara, CA (US)

(72) Inventors: Simon Pennycook, San Jose, CA (US); Christopher Hughes, Santa Clara, CA (US)

(73) Assignee: Intel Corporation, Santa Clara, CA (US)

(21) Appl. No.: 17/841,555

(22) Filed: Jun. 15, 2022

(51) Int. Cl. G06F 9/30; G06F 9/38

(52) U.S. Cl. CPC G06F 9/30101; G06F 9/3887; G06F 9/3804

(57) ABSTRACT

Techniques and mechanisms for determining a relative order in which respective microoperations of execution threads are performed. In an embodiment, a processor comprises a control register and circuitry which enables an executing program to set a control parameter which is provided by the control register. The control parameter determines whether the processor is to provide a control which applies one or more synchronization requirements to threads of execution which are of the same thread group. In another embodiment, the control is configurable to selectively provide implicit synchronization between some or all such threads.

### BACKGROUND

### 1. Technical Field

This disclosure generally relates to processor architectures and more particularly, but not exclusively, to an operational mode which disables a constraint on instruction execution.

### 2. Background Art

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O) operations. It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The various embodiments of the present invention are illustrated by way of example, and not by way of limitation, in the figures of the accompanying drawings and in which:

FIG. 1 shows a functional block diagram illustrating features of a system to determine an execution of instructions according to an embodiment.

FIG. 2 shows a flow diagram illustrating features of a method to selectively determine a timing of an instruction execution according to an embodiment.

FIG. 3 shows a functional block diagram illustrating features of a processor to provide a configuration state which times an instruction execution according to an embodiment.

FIG. 4 shows a flow diagram illustrating features of a method to selectively determine a timing of an instruction execution according to an embodiment.

FIG. 5 shows a format diagram illustrating features of a control register to provide a configuration state of a processor core according to an embodiment.

FIG. 6 illustrates an exemplary system.

FIG. 7 illustrates a block diagram of an example processor that may have more than one core and an integrated memory controller.

FIG. 8A is a block diagram illustrating both an exemplary in-order pipeline and an exemplary register renaming, out-of-order issue/execution pipeline according to examples.

FIG. 8B is a block diagram illustrating both an exemplary example of an in-order architecture core and an exemplary register renaming, out-of-order issue/execution architecture core to be included in a processor according to examples.

FIG. 9 illustrates examples of execution unit(s) circuitry.

FIG. 10 is a block diagram of a register architecture according to some examples.

### DETAILED DESCRIPTION

Embodiments discussed herein variously provide techniques and mechanisms for determining a relative order in which respective microoperations of execution threads are performed. Modern processors often include instructions to provide operations that are computationally intensive, but offer a high level of data parallelism that can be exploited through an efficient implementation using various data storage devices, such as for example, single instruction multiple data (SIMD) vector registers. The central processing unit (CPU) may then provide parallel hardware to support processing vectors. A vector is a data structure that holds a number of consecutive data elements. A vector register of size M (where M is e.g., 512, 256, 128, 64, 32, . . . , 4 or 2) may contain N vector elements of size O, where N=M/O. For instance, a 64-byte vector register may be partitioned into (a) 64 vector elements, with each element holding a data item that occupies 1 byte, (b) 32 vector elements to hold data items that occupy 2 bytes (or one “word”) each, (c) 16 vector elements to hold data items that occupy 4 bytes (or one “doubleword”) each, or (d) 8 vector elements to hold data items that occupy 8 bytes (or one “quadword”) each.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) often require the same operation to be performed on a large number of data items. Single Instruction Multiple Data (SIMD) refers to a type of instruction that causes a processor to perform an operation on multiple data elements. SIMD technology is used, for example, in processors that can logically divide the bits in a register into a number of fixed-sized or variable-sized data elements, each of which represents a separate value. For example, in one embodiment, the bits in a 64-bit register are organized as a source operand containing four separate 16-bit data elements, each of which represents a separate 16-bit value. This type of data is sometimes referred to as a “packed” data type or a “vector” data type, and operands of this data type are referred to as packed data operands or vector operands. In one embodiment, a packed data item or vector is a sequence of packed data elements stored within a single register, and a packed data operand or a vector operand is a source or destination operand of a SIMD instruction (or “packed data instruction” or a “vector instruction”). In one embodiment, a SIMD instruction specifies a single vector operation to be performed on two source vector operands to generate a destination vector operand (also referred to as a result vector operand) of the same or different size, with the same or different number of data elements, and in the same or different data element order.

SIMD technology—such as that employed by the Intel® Core™ processors having an instruction set including x86, MMX™, Streaming SIMD Extensions (SSE), SSE2, SSE3, SSE4.1, and SSE4.2 instructions, ARM processors, such as the ARM Cortex® family of processors having an instruction set including the Vector Floating Point (VFP) and/or NEON instructions, and MIPS processors, such as the Loongson family of processors developed by the Institute of Computing Technology (ICT) of the Chinese Academy of Sciences—has enabled a significant improvement in application performance (Core™ and MMX™ are registered trademarks or trademarks of Intel Corporation of Santa Clara, Calif.).

Single program, multiple data (SPMD) programming is one example of a technology which facilitates the performance of multiple operational sequences, over a common period of time, by the same processor resources (such as a circuitry of one shared core, for example). The term “thread of execution” is used herein to refer to a given one such operational sequence. For example, multiple threads of execution each correspond to a different respective control flow in the same program—e.g., wherein said control flows are independent of each other. In some embodiments, a thread of execution includes or is otherwise associated with its own dedicated program counter, memory region(s), stack, and/or other resources.

SPMD programs and SIMD programs, for example, variously associate some multiple threads of execution with each other—e.g., wherein the multiple threads of execution are to be implemented with the same dedicated core (or other suitable processor circuitry). For example, threads of execution are mapped to, or otherwise implemented based on, different respective data elements of a given SIMD vector. Unless otherwise indicated, such an association of threads of execution with each other is referred to herein with any of the terms “group of threads,” “thread group” (or simply “group,” for brevity), “packaged threads,” “thread package” (or simply “package,” for brevity) or “warp.”

Many SPMD implementations map a given program to hardware by associating some multiple threads of execution with each other, and executing said threads of execution using SIMD instructions. On many occasions, programmers write a given software application in a way which implicitly relies upon processor hardware to enforce synchronization between threads of execution in a group. Often, such programming results in excessive synchronization constraints and/or other associated performance limits.

For example, in a typical SPMD program, multiple threads of execution each load a respective input from non-contiguous memory, perform some computation, and write a respective result to a unique memory location. Mapping such a program to SIMD instructions is often wasteful since the execution of each thread of execution would be implicitly synchronized with all other threads of execution packed into the same SIMD vector. Often this synchronization exceeds that which is strictly required for correctness of the program execution.

Furthermore, in writing a given software program, developers often fail to explicitly synchronize a given two or more threads of execution—e.g., on a presumption that such synchronization will implicitly be provided by the execution being according to a given SIMD execution model. However, such a software program is sometimes prone to failure when it is moved to execute on a different processor architecture. In a typical scenario, a data race takes place in the absence of explicit software synchronization between a write to, and read from, a thread group's scratchpad memory. In a data race, one thread of execution runs ahead of one or more other threads of execution, and writes to and reads from the group's scratchpad memory without first synchronizing with the other threads of execution in the same group.

As used herein with respect to a given group of multiple threads of execution, “thread synchronization,” “synchronization,” “synchronized” and related terms variously refer to the provisioning of a particular relative order between the execution of one or more operations (e.g., one or more microoperations) of one thread of execution, and the execution of one or more other operations of a different thread of execution. In such a context, “explicit synchronization” refers herein to thread synchronization which is provided by processor hardware based on one or more instructions of a program explicitly requesting or otherwise stating that such synchronization is to be provided. By contrast, “implicit synchronization” refers herein to thread synchronization which is provided by processor hardware in the absence of any such one or more explicit instructions.

Some embodiments variously improve the efficiency of thread execution by variously providing control circuitry which is operable to selectively enable or disable implicit synchronization functionality. On various conventional processors, where code is either scalar or SIMD, this efficiency is not available. For example, currently, once a SPMD program has been compiled to SIMD instructions, processor hardware is unable to identify if the original expression of the original code would allow for more flexible scheduling of operations. Similarly, once a SPMD program has been compiled to scalar instructions (for separate threads of execution), conventional processor hardware cannot identify whether implicit synchronization might not be required for correctness.

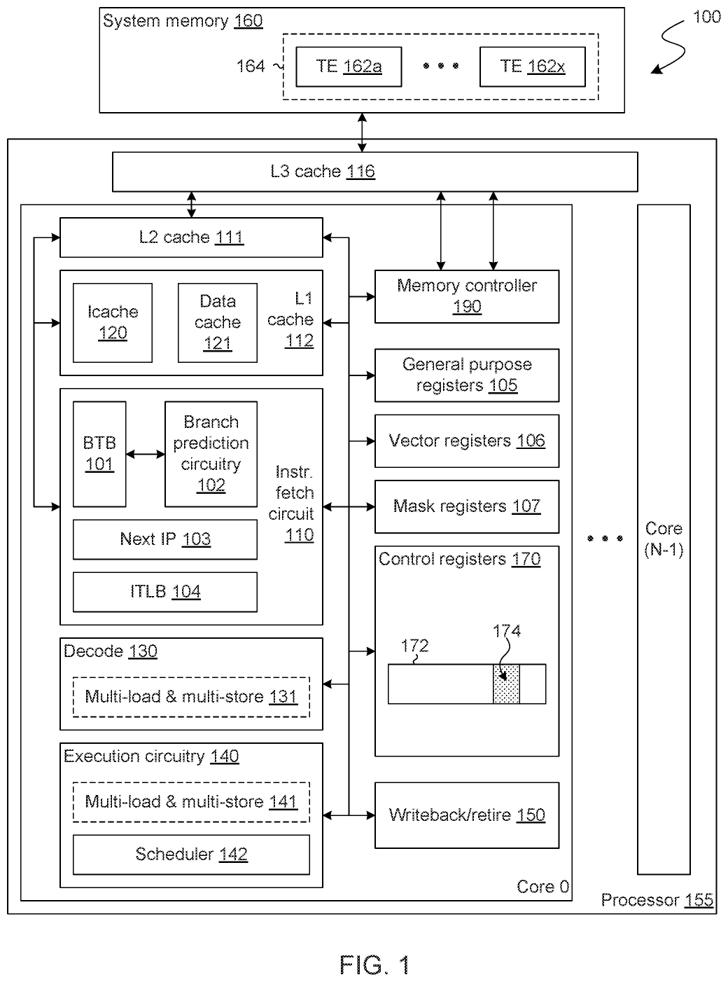

FIG. 1 shows features of a system 100 comprising processor hardware to selectively enable or disable a thread synchronization functionality according to an embodiment. System 100 illustrates one example embodiment wherein a processor comprises a control register (or other suitable circuitry) which is configurable—e.g., by a thread of execution in a thread group—to disable the application of a thread timing constraint that would otherwise result in a particular order in which one or more microoperations of one thread of execution are performed relative to one or more microoperations of another thread of execution.

As shown in FIG. 1, system 100 comprises a processor 155 and a system memory 160 which is coupled thereto. Processor 155 includes any of various types of processors such as, for example, a micro-processor, an embedded processor, a digital signal processor (DSP), a central processing unit (CPU), a graphical processing unit (GPU), a visual processing unit (VPU), a network processor, a device to execute code to implement the technologies described herein, and so on, or combinations thereof. In various embodiments, processor 155 includes one or more cores—e.g., including the illustrative N cores 0 through (N−1) shown (where N is a positive integer). In one such embodiment, processor 155 includes one or more single-threaded cores, multithreaded cores including more than one hardware thread context (or “logical processor”) per core, and so on, or combinations thereof.

Processor 155 includes a plurality of cores 0 through (N−1) for simultaneously implementing multiple threads of execution. The illustrated embodiment includes multi-load and multi-store decode circuitry/logic 131 within the decoder 130 and multi-load and multi-store instruction execution circuitry/logic 141 within the execution unit 140. In response to executing these instructions, a memory controller 190 implements the underlying load/store operations by accessing a memory subsystem of the processor which includes a system memory 160, a Level 3 cache 116 shared among the cores, and/or other cache levels (e.g., such as L2 cache 111). These pipeline components perform operations responsive to the decoding and execution of the multi-load and multi-store instructions. While details of only a single core (Core 0) are shown in FIG. 1, it will be understood that some or all of the other cores of processor 155 each include similar components.

Prior to describing specific details of some embodiments, a description of various other components of the exemplary processor 155 is provided. In one embodiment, some or all of the plurality of cores 0 through (N−1) each include a memory controller 190 for performing memory operations (e.g., such as load/store operations), a set of general purpose registers (GPRs) 105, a set of vector registers 106, a set of mask registers 107, and a set of control registers 170. In one embodiment, multiple vector data elements are packed into each vector register 106 which (for example) have a 512-bit width for storing two 256 bit values, four 128 bit values, eight 64 bit values, sixteen 32 bit values, etc. However, the underlying principles of the invention are not limited to any particular size/type of vector data. In one embodiment, the mask registers 107 include eight 64-bit operand mask registers used for performing bit masking operations on the values stored in the vector registers 106. However, various embodiments are not limited to any particular mask register size/type, and some embodiments omit some or all such mask registers.

In an embodiment, some or all of cores 0 through (N−1) each include a respective dedicated Level 1 (L1) cache 112 and Level 2 (L2) cache 111 for caching instructions and data according to a specified cache management policy. In an alternate embodiment, each L2 cache is shared among two or more cores. The L1 cache 112 includes a separate instruction cache (Icache) 120 for storing instructions and a separate data cache 121 for storing data. The instructions and data stored within the various processor caches are managed at the granularity of cache lines which is a fixed size (e.g., 64, 128, 512 bytes in length). Each core of this exemplary embodiment has an instruction fetch circuit 110 for fetching instructions from main memory 160 and/or a shared Level 3 (L3) cache 116. The instruction fetch circuit 110 includes various well known components including a next instruction pointer (IP) 103 for storing the address of the next instruction to be fetched from memory 160 (or one of the caches), an instruction translation look-aside buffer (ITLB) 104 for storing a map of recently used virtual-to-physical instruction addresses to improve the speed of address translation, a branch prediction unit 102 for speculatively predicting instruction branch addresses, and a branch target buffer (BTB) 101 for storing branch addresses and target addresses.

As mentioned, a decode unit 130 includes multi-load and multi-store circuitry/logic 131 for decoding the multi-load and multi-store instructions into micro-operations or “microoperations” and the execution unit 140 includes multi-load and multi-store instruction execution circuitry/logic 141 for executing the microoperations. A writeback/retirement unit 150 retires the executed instructions and writes back the results.

In one implementation, a multi-load instruction loads several non-contiguous elements from memory (e., N elements, possibly from N different cache lines) to fill a single vector register with one instruction and a multi-store instruction stores data elements from a single vector register to non-contiguous memory locations with one instruction. The term “multi-load/store” instruction is sometimes used herein when referring to features which are applicable to both of these instructions. In one embodiment, a vector index register contains a plurality of packed integer values which are used as indexes to load and store data elements. For example, with 512-bit registers, eight 32-bit indexes or sixteen 16-bit indexes are stored. Similarly, for 256-bit registers, four 32-bit indexes or eight 16-bit indexes are stored. While these values are provided for the purpose of illustration, some embodiments are not limited to any particular data element size or register size.

In general, assuming that there are X indexes stored in an index vector register, one embodiment of the multi-load/store instruction computes X effective addresses by adding each index to a base address (stored in a base address register). The multi-load instruction then loads a single element from each address into its corresponding location in the destination vector register. The multi-store instruction retrieves packed data from its vector register and stores the elements to the X calculated effective addresses in memory (e.g., one data element to each address).

Some embodiments improve the efficiency of a thread group's execution by providing a control register 172 of control registers 170 (or providing any of various other suitable hardware resources of core 0) to enable the selective configuring of a control for said execution. In one such embodiment, control register 172 comprise a bit 174 which is (re)configurable by software to specify or otherwise indicate a state of enablement—e.g., the state being one of an enabled state or a disabled state—of a control which is to apply one or more synchronization requirements to some or all threads of a thread group. In some embodiments, when such a control (referred to herein as a “thread synchronization control,” or simply “synchronization control”) is enabled by control register 172, scheduler 142 (or other suitable circuitry of core 0) applies the one or more synchronization requirements implicitly. By contrast, enforcement of the one or more synchronization requirements is prevented—e.g., unless explicitly requested by a thread—when the synchronization control is disabled.

A given synchronization requirement comprises one or more requirements with respect to an order of execution by multiple threads of execution. For example, according to one such synchronization requirement—and, for example, based on one or more characteristics of the thread group's execution—one or more microoperations of one thread of execution are to be executed before (or alternatively, after) one or more microoperations of a different thread of execution.

In an illustrative scenario according to one embodiment, core 0 executes a program which provides multiple threads of execution (such as the example threads of execution TE 162a, . . . , TE 162x shown), which are packaged or otherwise associated with each other in a thread group 164. For example, execution of the program core 0 is to successively execute respective instructions of TE 162a, . . . , TE 162x—e.g., after a given one instruction is decoded into a respective one or more microoperations to be executed. At some point during execution of the program with core 0, execution circuitry 140 executes an instruction to access control register 172—e.g., wherein said access is to set an enablement state of a synchronization control. Based on such an access, scheduler 142 is transitioned to a particular one of a first operational mode wherein the synchronization control is enabled, and a second operational mode wherein the synchronization control is disabled. Subsequently, scheduler 142 operates according to the configured operational mode to determine an order in which one or more microoperations of one of TE 162a, . . . , TE 162x are performed relative to one or more microoperations of another of TE 162a, . . . , TE 162x.

In some embodiments, thread execution, according to one of the first operational mode or the second operational mode, is further based on one or more additional synchronization control parameters which—for example—are defined by another field (not shown) of register 172. For example, register 172 (or another suitable resource of core 0) can be further configurable to receive additional information which specifies or otherwise indicates a total number of threads of execution in a thread group—e.g., all threads in a given thread group, or merely a sub-set thereof—for which implicit thread synchronization is to be disabled. In one such embodiment, such additional information, in combination with bit 174, enables scheduler 142 to not only determine whether hardware is to enforce implicit thread synchronization, but also to more specifically determine whether (or not) implicit synchronization is to be provide with respect to a particular two threads of execution.

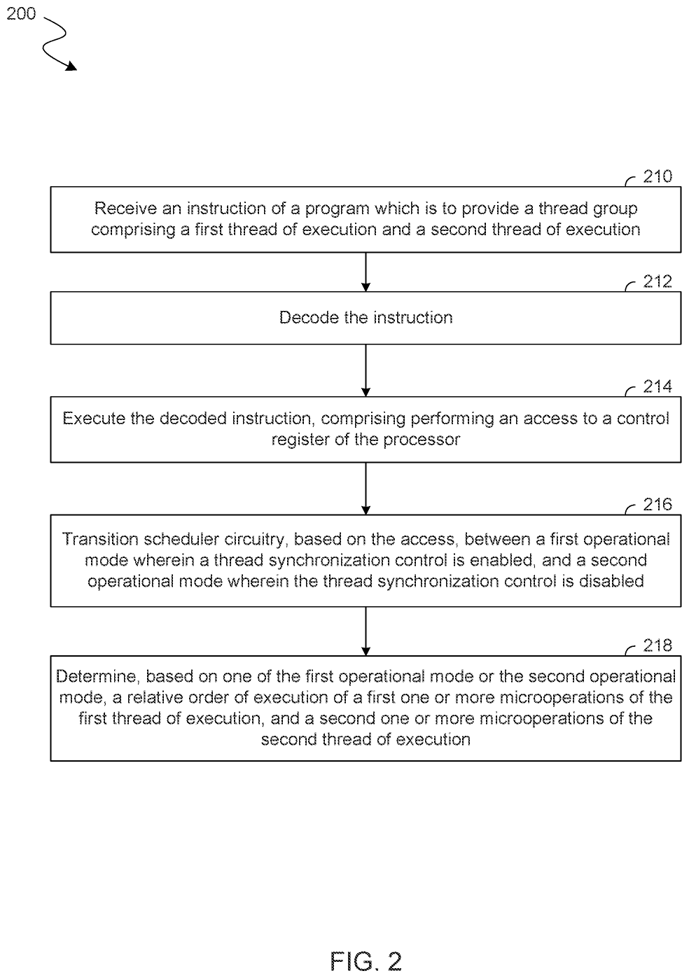

FIG. 2 shows features of a method 200 which is performed at a processor to selectively determine a timing of an instruction execution according to an embodiment. For example, method 200 is performed at a given core (such as core 0) of processor 155.

As shown in FIG. 2, method 200 comprises (at 210) receiving an instruction of a program which is to provide a thread group comprising a first thread of execution and a second thread of execution. For example, an instance of single instruction is fetched from Icache 120 by instruction fetch circuit 110, or is otherwise provided to decode unit 130. In some embodiments, the instruction is adapted from any of various existing types of mode register set (or other) instructions—e.g., one from of an x86 instruction set, an ARM instruction set or the like—which write to a control register or otherwise set an operational mode of processor circuitry such as scheduler 142 (and/or other suitable circuitry of execution circuitry 140). In one such embodiment, the instruction includes one or more fields each for a respective one of an opcode, and (in some embodiments) one or more operands. The respective values of said fields specify or otherwise indicate a control register which is to be targeted, one or more bits of the control register, and a value (or values) to be written to said one or more bits.

The fetched instruction is decoded at 212. For example, the fetched instruction is decoded by decoder circuitry such as decode unit 130 or decode circuitry 840 detailed herein.

Method 200 further comprises (at 214) executing the decoded instruction, comprising performing an access to a control register of the processor. For example, the executing at 214 includes or otherwise results in bit 174 of control register 172 being set to a value which is to disable (or alternatively, is to enable) the implicit application of one or more thread synchronization requirements. Based on such an access to the control register, method 200 (at 216) transitions scheduler circuitry of the processor between a first operational mode wherein a thread synchronization control is enabled, and a second operational mode wherein the thread synchronization control is disabled. While enabled, the thread synchronization control provides implicit thread synchronization by applying one or more synchronization requirements to threads of execution which are each of the same thread group. In some embodiments, the first operational mode is a default mode of the scheduler circuitry—e.g., wherein implicit thread synchronization is provided unless a program explicitly sets a state of processor hardware to disable some or all such implicit thread synchronization.

Based on one of the first operational mode or the second operational mode—e.g., the operational mode transitioned to at 216—method 200 (at 218) determines a relative order of execution of a first one or more microoperations of the first thread of execution, and a second one or more microoperations of the second thread of execution. Although some embodiments are not limited in this regard, the first thread of execution and the second thread of execution are each based on a single instruction, multiple data (SIMD) instruction, for example.

By way of illustration and not limitation, an execution of the first one or more microoperations would, according to the one or more synchronization requirements, be performed (for example) after a completion of an execution of the second one or more microoperations. However, in one such scenario, the scheduler circuitry is transitioned at 216 to the second operational mode, which disables implicit application of the one or more synchronization requirements. As a result, determining the order of execution at 218 comprises, based on the second operational mode, preventing a delay to an execution of the first one or more microoperations. In an embodiment, the delay is prevented due to the second operational mode disabling an evaluation to determine whether said delay is to be applied.

In another illustrative scenario, the first thread of execution follows a first path of a branch instruction of the program, wherein the second thread of execution follows a second (i.e., different) path of the branch instruction. In this example, an execution of the first one or more microoperations based on the first path would, according to the one or more synchronization requirements, be performed (for example) prior to an execution of the second one or more microoperations based on the second path—e.g., because of the particular paths taken. However, in this scenario, the scheduler circuitry is transitioned at 216 to the second operational mode. As a result, determining the order of execution at 218 comprises, based on the second operational mode, selecting the second one or more microoperations to be executed prior to an execution of the first one or more microoperations. In an embodiment, the second operational mode disables an evaluation which would otherwise determine that an alternative thread selection is to be made.

In still another illustrative scenario, the scheduler circuitry detects a condition wherein a target of the first one or more microoperations spans multiple lines of a cache. In this example, according to the one or more synchronization requirements, the scheduler circuitry would provide, based on the condition, an indication of a delay to be applied (for example) before an execution of the second one or more microoperations. However, in this scenario, the scheduler circuitry is transitioned at 216 to the second operational mode, wherein—based on the second mode (for example) the scheduler circuitry foregoes providing such an indication of the delay. In an embodiment, the delay is prevented due to the second operational mode disabling an evaluation to determine whether said delay is to be applied.

In some embodiments, the second operational mode results in a change in a relative order in which microoperations are performed (e.g., as compared to an alternative order which would otherwise be provided based on the first operational mode). In one such embodiment, the change in relative order takes place at a finer level of granularity than an instruction-level granularity. For example, in various embodiments, execution of a first instruction by the first thread of execution comprises executing the first one or more microoperations, as well as some third one or more microoperations. In one illustrative scenario, an execution of the plurality of microoperations would, according to the one or more synchronization requirements, be performed (for example) after a completion of an execution of the second one or more microoperations. However, based on the second operational mode, the second one or more microoperations are executed after the first one or more microoperations, and before the third one or more microoperations.

In some embodiments, method 200 further comprises additional operations (not shown) to transition the scheduler circuitry to an operational mode other than that which is provided at 216. By way of illustration and not limitation, such operations comprise receiving, decoding, and executing a second instruction to change the synchronization control parameter which is set or otherwise determined by the access performed at 214. For example, the second instruction is one instruction of the same program which provides the first and second threads of execution. In one such embodiment, executing the second instruction transitions the scheduler circuit from the second operational mode to the first operational mode—e.g., wherein the thread synchronization control is disabled for one portion of the executing program, but is enabled for one or more other portions of that same executing program. Subsequently, based on the first operational mode, the scheduler circuit determines an order of execution of other microoperations—e.g., including an order of a third one or more microoperations of the first thread of execution, relative to a fourth one or more microoperations of the second thread of execution.

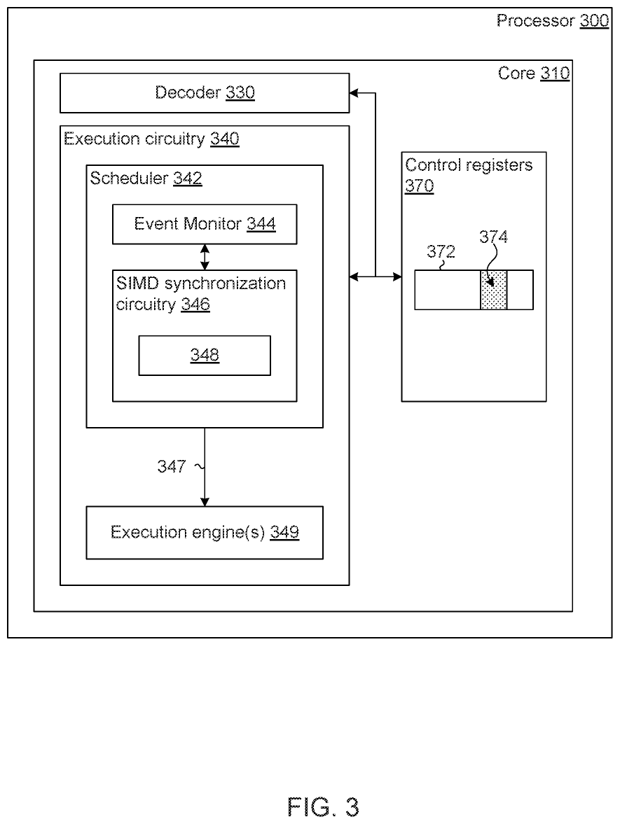

FIG. 3 shows features of a processor 300 to provide a configuration state which times an instruction execution according to an embodiment. Processor 300 illustrates one example of an embodiment wherein a processor core is (re)configurable, by one or more software instructions, to selectively disable or enable a control which provides one or more types of implicit synchronization between multiple threads of execution of a given thread package. In various embodiments, processor 300 provides functionality such as that of processor 155—e.g., wherein one or more operations of method 200 are performed with processor 300.

As shown in FIG. 3, processor 300 comprises a core 310 which (for example) corresponds functionally to core 0 of processor 155. Core 310 comprises a decoder 330, execution circuitry 340, and control registers 370 which, in some embodiments, correspond functionally to decode unit 130, execution circuitry 140, and control registers 170 (respectively). A scheduler 342 of execution circuitry 340 provides functionality of scheduler 142, for example—e.g., wherein a control register 372 of control registers 370 provides functionality of control register 172.

In some embodiments, one or more other cores (not shown) of processor 300 each comprise a respective control register which provides functionality of control register 372—e.g., wherein each of the N cores 0 through (N−1) of processor 155 have a respective register which provides functionality similar to that of control register 172. For each such other core of processor 300, the respective control register is accessible by software to (re)configure an enablement state of a synchronization control that is provided by a scheduler circuit (or other suitable circuitry) of that core.

In an illustrative scenario according to one embodiment, one or more execution engines 349 of execution circuitry 340 execute a mode set (or other) instruction of a program which provides a thread group comprising a first thread of execution and a second thread of execution—e.g., wherein microoperations of the thread group are executed by execution circuitry 340. Execution of the instruction comprises the execution engine(s) 349 accessing the control register 372 to set a value of a bit 374 which defines a synchronization control parameter. A value of bit 374 determines a current enablement state of a thread synchronization control which (for example) is provided with scheduler 342. In an embodiment, the thread synchronization control—when enabled—is to provide one or more types of inherent thread synchronization by applying one or more synchronization requirements (where applicable) to a given thread group

For example, based on the value of bit 374, SIMD synchronization circuitry 346 of scheduler 342 receives a configuration state 348 whereby the thread synchronization control is disabled (or alternatively, is enabled). An event monitor 344 of scheduler 342 provides functionality to detect that a given event—e.g., including an occurrence of a particular state of the multiple threads of execution—is one of a predetermined event type which corresponds to a synchronization requirement. By way of illustration and not limitation, in one embodiment, such an event comprises an instance of a first one or more microoperations of one thread of execution needing to be executed, wherein it is indicated that there is a data dependency between the first one or more microoperations, and a second one or more microoperations of another thread of execution. In another embodiment, such an event comprises an instance of a microoperation of a thread targeting data which spans multiple lines of a cache, wherein there is an indication of a possible delay needed to access the multiple lines of cache. In still another embodiment, such an event comprises an instance of a first thread of execution taking a first path of a branch instruction—e.g., wherein a determination of when to execute one or more microoperations based on the first path would (according to an implicit synchronization requirement) be conditioned upon whether a second thread of execution takes a different path of that same branch instruction.

Based on the event detected by event monitor 344, and further based on a current operational mode of SIMD synchronization circuitry 346 (the operational mode based on configuration state 348), scheduler 342 determines a particular order of execution of one or more microoperations of one thread—e.g., the order relative to one or more microoperations of a different thread of the same thread group. The particular order is indicated with a signal 347 which communicates to execution engine(s) 349 whether, for example, a delay is to be applied to an execution of a given microoperation.

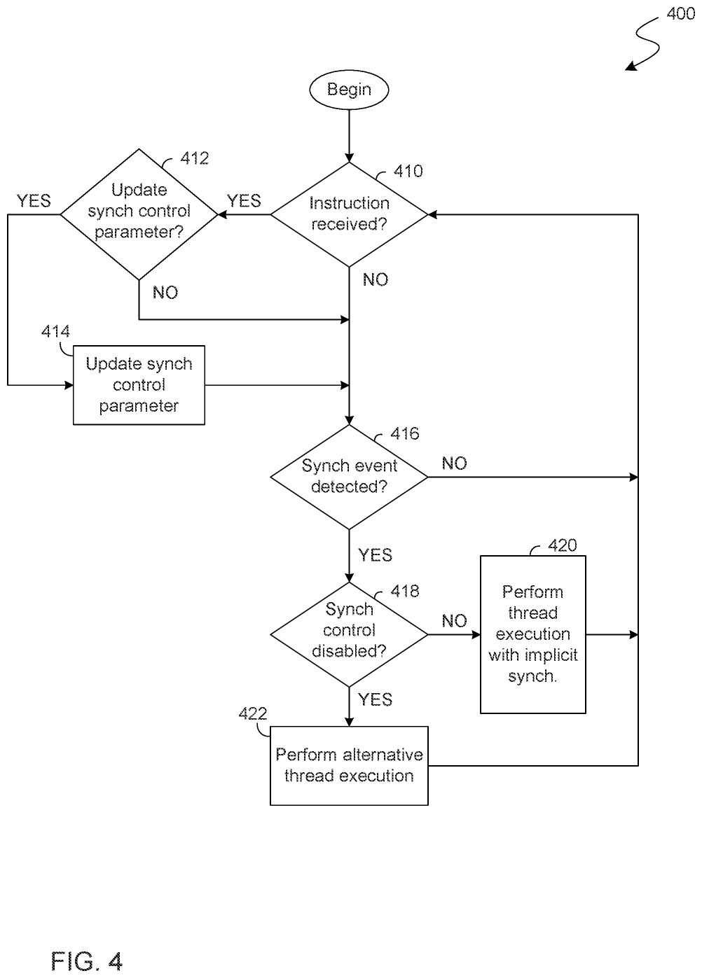

FIG. 4 shows features of a method 400 to selectively determine a timing of a program execution according to an embodiment. Method 400 illustrates one example of an embodiment wherein an operational mode of a processor determines whether a synchronization requirement is to be inherently applied to threads of execution. Operations such as those of method 400 are performed, for example, with processor 155 or processor 300—e.g., wherein such method 200 includes or is otherwise based on some or all such operations.

As shown in FIG. 4, method 400 comprises performing an evaluation (at 410) to determine whether a next instruction of the program has been received for execution (and, in some embodiments, for decoding prior to such execution). For example, the evaluation at 410 determines whether instruction fetch circuit 110, decode unit 130 or other such processor resources have provided an instruction (or a decoded version thereof).

Where it is determined at 410 that such an instruction has been received, method 400 performs an evaluation (at 412) to determine whether an execution of the instruction is to update a synchronization control parameter such as one defined by one of bits 174, 374. Where it is determined at 412 that such an update is to be performed, method 400 (at 414) accesses a corresponding control register (e.g., one of registers 172, 372) to perform the update. Where it is instead determined at 412 that no such update is needed, method 400 instead proceeds to perform a next evaluation at 416 (e.g., wherein other operations to execute the instruction are not shown in FIG. 4).

For example, where it is instead determined at 410 that no instruction has been received, method 400 performs an evaluation (at 416) to determine whether a synchronization event has been detected. In this particular context, “synchronization event” refers herein to a thread execution event which is of a predetermined type that corresponds to one or more synchronization requirements. The one or more synchronization requirements are to be selectively applied (or prevented from being applied) based on an operational mode of the processor core in question. For example, the operational mode includes an enablement state of a control which corresponds to the synchronization control parameter—e.g., wherein the control, when enabled, is to implicitly apply the one or more synchronization requirements.

Where it is determined at 416 that no such synchronization event is detected, method 400 performs a next instance of the evaluating at 410. Where it is instead determined at 416 that a synchronization event is detected, method 400 performs an evaluation (at 418) to determine, based on the synchronization control parameter, whether the synchronization control is currently disabled.

Where it is determined at 418 that the synchronization control is enabled, method 400 (at 420) performs an execution of a given thread with the implicit synchronization which is provided according to the one or more synchronization requirements. After the thread execution at 420, method 400 performs a next instance of the evaluating at 410.

Where it is instead determined at 418 that the synchronization control is disabled, method 400 (at 422) performs an alternative thread execution which is different to that which would otherwise be performed at 420. For example, the execution at 422—as compared to the execution at 420—foregoes an application of an execution delay and/or changes a relative order of execution of the respective microoperations of two threads. After the thread execution at 422, method 400 performs a next instance of the evaluating at 410.

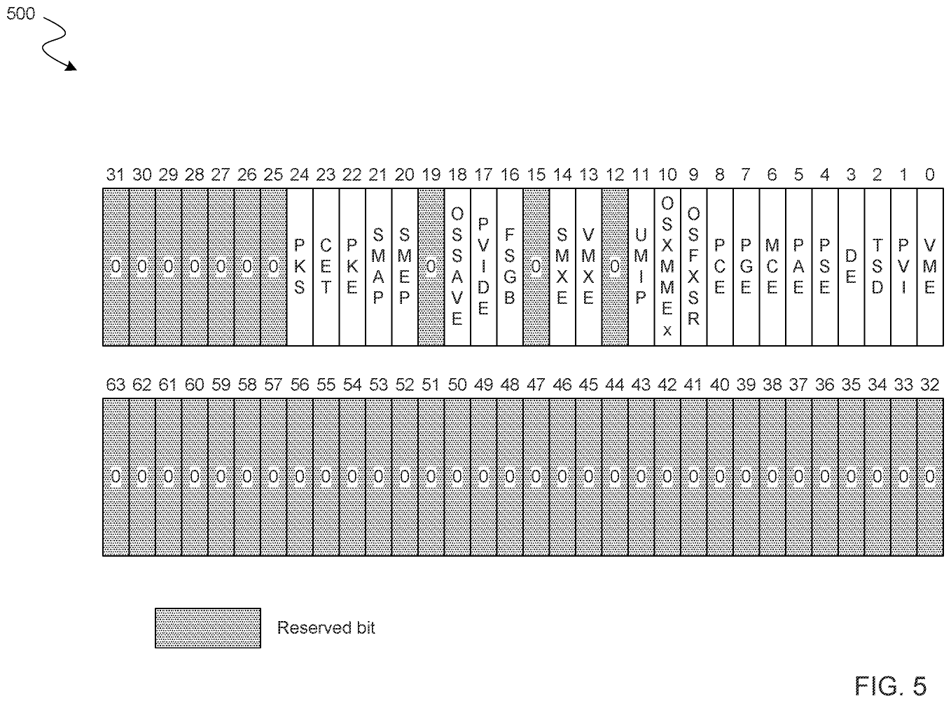

FIG. 5 shows features of a control register 500 to provide a configuration state of a processor core according to an embodiment. Control register 500 illustrates one example of a processor register which could be adapted to provide functionality such as that of control register 172, or control register 372 (for example)—e.g., wherein operations of method 200 and/or method 400 include or are otherwise based on the execution of an instruction to access such a control register.

As shown in FIG. 5, control register 500 has a format which is compatible with that of a CR4 control register of an Intel® 64 and IA-32 processor architecture. A listing of the fields in control register 500 is shown in the Table 1 below.

TABLE 1
Control Register Fields

| Bit(s) | Label | Description |
|---|---|---|
| 0 | VME | Virtual-8086 mode extensions |
| 1 | PVI | Protected mode virtual interrupts |
| 2 | TSD | Time stamp enabled only in ring 0 |
| 3 | DE | Debugging extensions |
| 4 | PSE | Page size extension |
| 5 | PAE | Physical address extension |
| 6 | MCE | Machine check exception |
| 7 | PGE | Page global enable |
| 8 | PCE | Performance monitoring counter enable |
| 9 | OSFXSR | OS support for fxsave and fxrstor instructions |
| 10 | OSXMMEXCPT | OS support for unmasked simd floating point |
| | | exceptions |
| 11 | UMIP | User-mode instruction prevention (SGDT, |
| | | SIDT, SLDT, SMSW, and STR are disabled |
| | | in user mode) |
| 12 | 0 | Reserved |
| 13 | VMXE | Virtual machine extensions enable |
| 14 | SMXE | Safer mode extensions enable |
| 15 | 0 | Reserved |
| 16 | FSGSBASE | Enables the instructions RDFSBASE, |
| | | RDGSBASE, WRFSBASE, and WRGSBASE |
| 17 | PCIDE | PCID Enable |
| 18 | OSXSAVE | XSAVE and processor extended states enable |
| 19 | 0 | Reserved |
| 20 | SMEP | Supervisor mode executions protection enable |
| 21 | SMAP | Supervisor mode access protection enable |
| 22 | PKE | Enable protection keys for user-mode pages |
| 23 | CET | Enable control-flow enforcement technology |
| 24 | PKS | Enable protection keys for supervisor-mode |
| | | pages |
| 25-63 | 0 | Reserved |

In various embodiments, a reserved bit of control register 500—e.g., one of the reserved bits 12, 15, 19, or 25-63—is repurposed or otherwise adapted to function as bit 174, as bit 374, or as any of various other such repositories of a synchronization control parameter. In another embodiment, such a synchronization control parameter is provided (for example) by a similar adaptation of a reserved bit in any of various other such processor registers, such as a MXCSR register of an Intel processor.

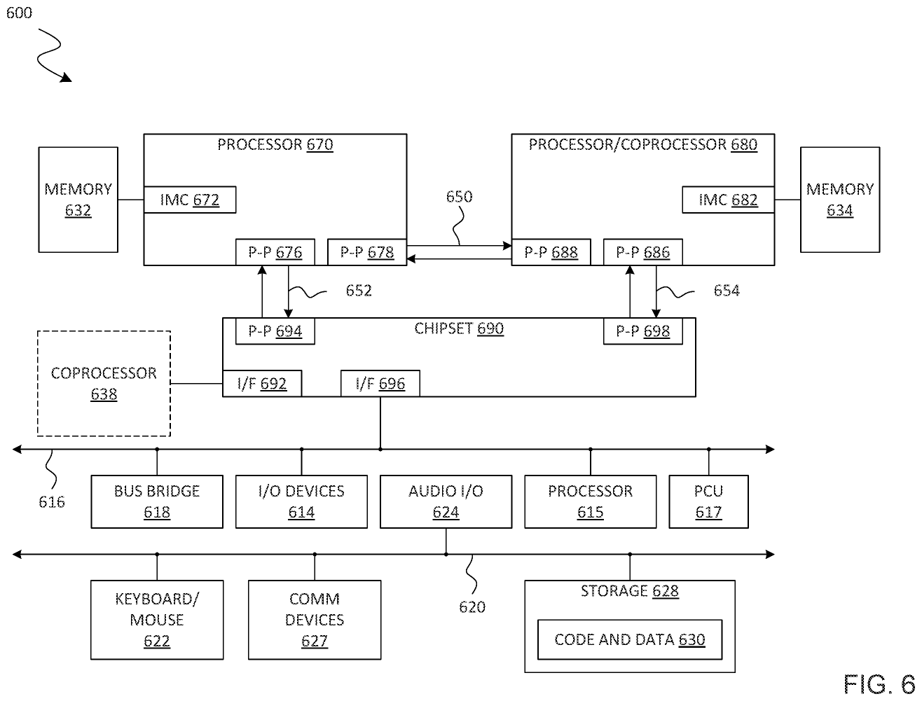

FIG. 6 illustrates an exemplary system. Multiprocessor system 600 is a point-to-point interconnect system and includes a plurality of processors including a first processor 670 and a second processor 680 coupled via a point-to-point interconnect 650. In some examples, the first processor 670 and the second processor 680 are homogeneous. In some examples, first processor 670 and the second processor 680 are heterogenous. Though the exemplary system 600 is shown to have two processors, the system may have three or more processors, or may be a single processor system.

Processors 670 and 680 are shown including integrated memory controller (IMC) circuitry 672 and 682, respectively. Processor 670 also includes as part of its interconnect controller point-to-point (P-P) interfaces 676 and 678; similarly, second processor 680 includes P-P interfaces 686 and 688. Processors 670, 680 may exchange information via the point-to-point (P-P) interconnect 650 using P-P interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a chipset 690 via individual P-P interconnects 652, 654 using point to point interface circuits 676, 694, 686, 698. Chipset 690 may optionally exchange information with a coprocessor 638 via an interface 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via P-P interconnect, such that either or both processors' local cache information may be stored in the shared cache if a processor is placed into a low power mode.

Chipset 690 may be coupled to a first interconnect 616 via an interface 696. In some examples, first interconnect 616 may be a Peripheral Component Interconnect (PCI) interconnect, or an interconnect such as a PCI Express interconnect or another I/O interconnect. In some examples, one of the interconnects couples to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interconnect 616, along with a bus bridge 618 which couples first interconnect 616 to a second interconnect 620. In some examples, one or more additional processor(s) 615, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 616. In some examples, second interconnect 620 may be a low pin count (LPC) interconnect. Various devices may be coupled to second interconnect 620 including, for example, a keyboard and/or mouse 622, communication devices 627 and a storage circuitry 628. Storage circuitry 628 may be one or more non-transitory machine-readable storage media as described below, such as a disk drive or other mass storage device which may include instructions/code and data 630 in some examples. Further, an audio I/O 624 may be coupled to second interconnect 620. Note that other architectures than the point-to-point architecture described above are possible. For example, instead of the point-to-point architecture, a system such as multiprocessor system 600 may implement a multi-drop interconnect or other such architecture.

Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

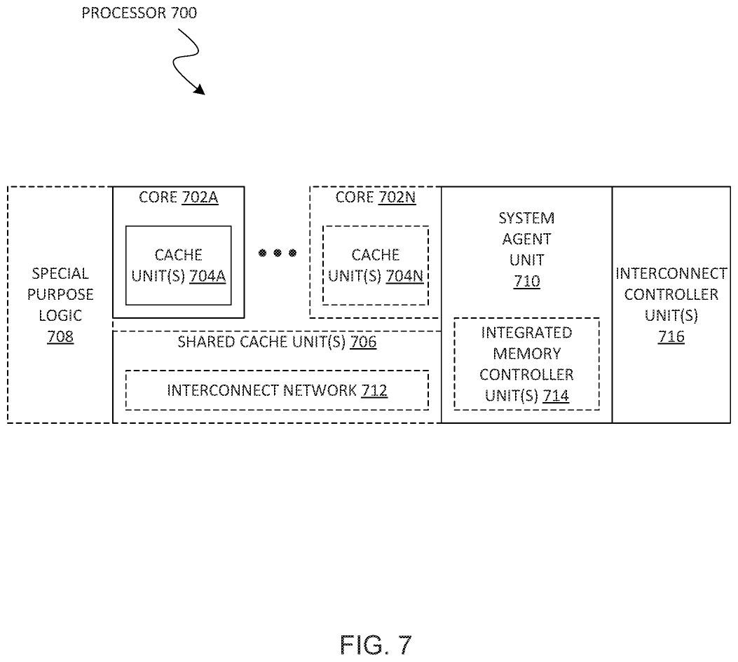

FIG. 7 illustrates a block diagram of an example processor 700 that may have more than one core and an integrated memory controller. The solid lined boxes illustrate a processor 700 with a single core 702A, a system agent unit circuitry 710, a set of one or more interconnect controller unit(s) circuitry 716, while the optional addition of the dashed lined boxes illustrates an alternative processor 700 with multiple cores 702A-N, a set of one or more integrated memory controller unit(s) circuitry 714 in the system agent unit circuitry 710, and special purpose logic 708, as well as a set of one or more interconnect controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702A-N being one or more general purpose cores (e.g., general purpose in-order cores, general purpose out-of-order cores, or a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704A-N within the cores 702A-N, a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples ring-based interconnect network circuitry 712 interconnects the special purpose logic 708 (e.g., integrated graphics logic), the set of shared cache unit(s) circuitry 706, and the system agent unit circuitry 710, alternative examples use any number of well-known techniques for interconnecting such units. In some examples, coherency is maintained between one or more of the shared cache unit(s) circuitry 706 and cores 702A-N.

In some examples, one or more of the cores 702A-N are capable of multi-threading. The system agent unit circuitry 710 includes those components coordinating and operating cores 702A-N. The system agent unit circuitry 710 may include, for example, power control unit (PCU) circuitry and/or display unit circuitry (not shown). The PCU may be or may include logic and components needed for regulating the power state of the cores 702A-N and/or the special purpose logic 708 (e.g., integrated graphics logic). The display unit circuitry is for driving one or more externally connected displays.

The cores 702A-N may be homogenous in terms of instruction set architecture (ISA). Alternatively, the cores 702A-N may be heterogeneous in terms of ISA; that is, a subset of the cores 702A-N may be capable of executing an ISA, while other cores may be capable of executing only a subset of that ISA or another ISA.

### Exemplary Core Architectures—In-Order and Out-of-Order Core Block Diagram.

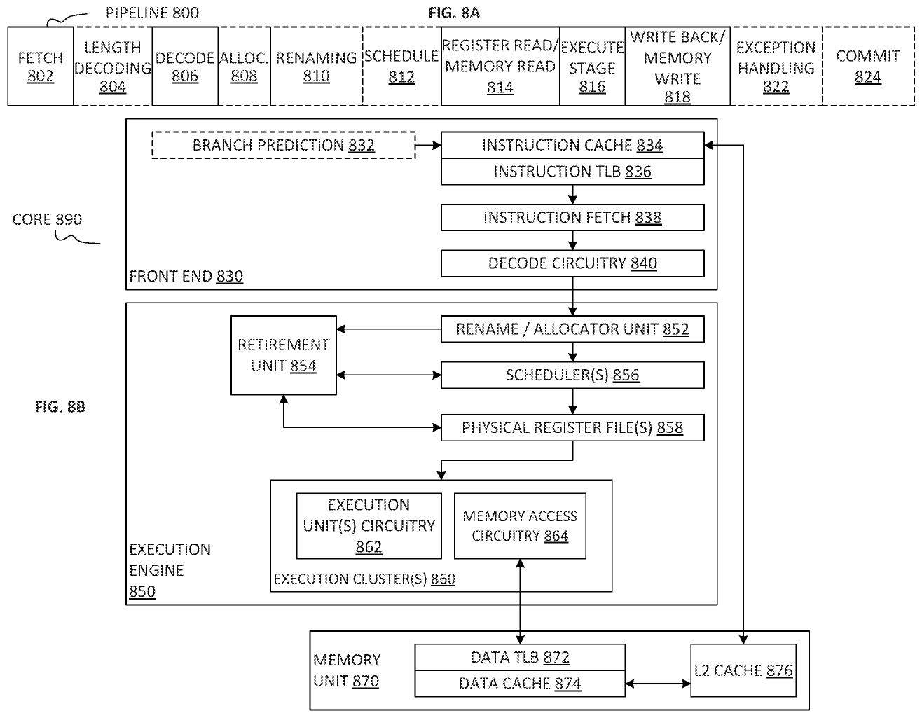

FIG. 8A is a block diagram illustrating both an exemplary in-order pipeline and an exemplary register renaming, out-of-order issue/execution pipeline according to examples. FIG. 8B is a block diagram illustrating both an exemplary example of an in-order architecture core and an exemplary register renaming, out-of-order issue/execution architecture core to be included in a processor according to examples. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 8B may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8B shows a processor core 890 including front-end unit circuitry 830 coupled to an execution engine unit circuitry 850, and both are coupled to a memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit circuitry 830 may include branch prediction circuitry 832 coupled to an instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to a retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, arithmetic generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB (s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to a data cache circuitry 874 coupled to a level 2 (L2) cache circuitry 876. In one exemplary example, the memory access circuitry 864 may include a load unit circuitry, a store address unit circuit, and a store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, a level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Exemplary Execution Unit(s) Circuitry.

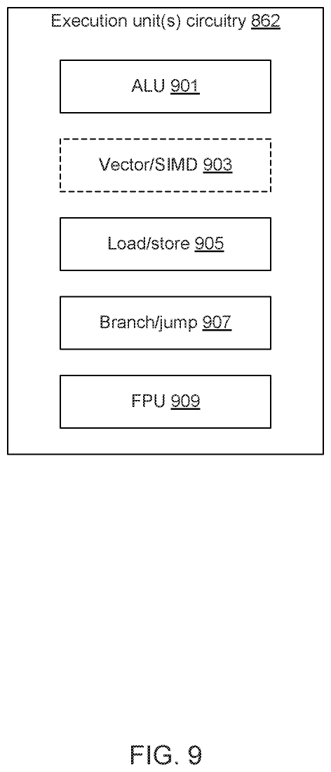

FIG. 9 illustrates examples of execution unit(s) circuitry, such as execution unit(s) circuitry 862 of FIG. 8B. As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

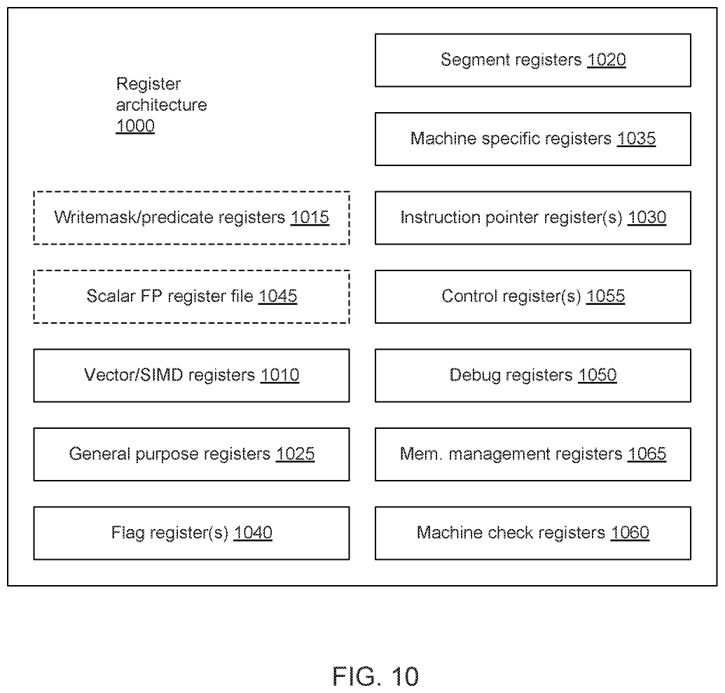

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1000 may, for example, be used in physical register file(s) circuitry 858.

In one or more first embodiments, a processor comprises a control register, first circuitry to execute an instruction of a program, wherein the first circuitry to execute the instruction comprises the first circuitry to perform an access to the control register, wherein the program is to provide a thread group which comprises a first thread of execution and a second thread of execution, and second circuitry coupled to the control register and the first circuitry, the second circuitry to transition, based on the access, between a first operational mode wherein a synchronization control is enabled, wherein the synchronization control is to apply one or more synchronization requirements to threads of execution, and a second operational mode wherein the synchronization control is disabled, and wherein the second circuitry is further to determine, based on one of the first operational mode or the second operational mode, an order of execution of a first one or more microoperations of the first thread of execution relative to a second one or more microoperations of the second thread of execution.

In one or more second embodiments, further to the first embodiment, according to the one or more synchronization requirements, an execution of the first one or more microoperations is to be performed after a completion of an execution of the second one or more microoperations, based on the access, the second circuitry is to transition to the second operational mode, and the second circuitry to determine the order of execution comprises, based on the second operational mode, the second circuitry to prevent a delay to an execution of the first one or more microoperations.

In one or more third embodiments, further to the first embodiment or the second embodiment, the first thread of execution is to follow a first path of a branch instruction of the program, the second thread of execution is to follow a second path of the branch instruction, according to the one or more synchronization requirements, an execution of the first one or more microoperations based on the first path is to be performed prior to an execution of the second one or more microoperations based on the second path, based on the access, the second circuitry is to transition to the second operational mode, and the second circuitry to determine the order of execution comprises, based on the second operational mode, the second circuitry to select the second one or more microoperations to be executed prior to an execution of the first one or more microoperations.

In one or more fourth embodiments, further to any of the first through third embodiments, the instruction is a first instruction, the access is a first access, based on the first access, the second circuitry is to transition to the second operational mode, the first circuitry is further to execute a second instruction of the program, wherein the first circuitry is to perform a second access to the control register, the second circuitry, based on the second access, is to transition from the second operational mode to the first operational mode, and the second circuitry is further to determine, based on the first operational mode, an order of execution of a third one or more microoperations of the first thread of execution relative to a fourth one or more microoperations of the second thread of execution.

In one or more fifth embodiments, further to any of the first through fourth embodiments, the second circuitry is further to detect a condition wherein a target of the first one or more microoperations spans multiple lines of a cache, according to the one or more synchronization requirements, the second circuitry is to provide, based on the condition, an indication of a delay to be applied before an execution of the second one or more microoperations, and based on the second mode, the second circuitry is to forego a communication of the indication of the delay.

In one or more sixth embodiments, further to any of the first through fifth embodiments, the control register is a first control register of a first core of the processor, the synchronization control is a first synchronization control to apply the one or more synchronization requirements at the first core, and the processor further comprises a second control register to determine an enablement state of a second synchronization control which is to apply the one or more synchronization requirements at a second core of the processor.

In one or more seventh embodiments, further to any of the first through sixth embodiments, an execution of a first instruction by the first thread of execution is to comprise an execution of a plurality of microoperations which comprise the first one or more microoperations and a third one or more microoperations, according to the one or more synchronization requirements, an execution of the plurality of microoperations is to be performed after a completion of an execution of the second one or more microoperations, and based on the second operational mode, the second one or more microoperations are to be executed after the first one or more microoperations, and before the third one or more microoperations.

In one or more eighth embodiments, further to any of the first through seventh embodiments, the first thread of execution and the second thread of execution are each to be based on a single instruction, multiple data (SIMD) instruction.

In one or more ninth embodiments, further to any of the first through eighth embodiments, the first operational mode is a default mode of the second circuitry.

In one or more tenth embodiments, a method at a processor, the method comprises executing an instruction of a program, wherein executing the instruction comprises performing an access to a control register of the processor, wherein the program is to provide a thread group which comprises a first thread of execution and a second thread of execution, and based on the access, transitioning scheduler circuitry of the processor between a first operational mode wherein a synchronization control is enabled, wherein the synchronization control is to apply one or more synchronization requirements to threads of execution, and a second operational mode wherein the synchronization control is disabled, and with the scheduler circuitry, determining, based on one of the first operational mode or the second operational mode, an order of execution of a first one or more microoperations of the first thread of execution relative to a second one or more microoperations of the second thread of execution.

In one or more eleventh embodiments, further to the tenth embodiment, according to the one or more synchronization requirements, an execution of the first one or more microoperations is to be performed after a completion of an execution of the second one or more microoperations, transitioning the scheduler circuitry based on the access comprises transitioning the scheduler circuitry to the second operational mode, and determining the order of execution comprises, based on the second operational mode, preventing a delay to an execution of the first one or more microoperations.

In one or more twelfth embodiments, further to the tenth embodiment or the eleventh embodiment, the first thread of execution is to follow a first path of a branch instruction of the program, the second thread of execution is to follow a second path of the branch instruction, according to the one or more synchronization requirements, an execution of the first one or more microoperations based on the first path is to be performed prior to an execution of the second one or more microoperations based on the second path, transitioning the scheduler circuitry based on the access comprises transitioning the scheduler circuitry to the second operational mode, and determining the order of execution comprises, based on the second operational mode, selecting the second one or more microoperations to be executed prior to an execution of the first one or more microoperations.

In one or more thirteenth embodiments, further to any of the tenth through twelfth embodiments, the instruction is a first instruction, the access is a first access, transitioning the scheduler circuitry based on the first access comprises transitioning the scheduler circuitry to the second operational mode, and the method further comprises executing a second instruction of the program, wherein executing the second instruction comprises performing a second access to the control register, and based on the second access, transitioning the scheduler circuitry from the second operational mode to the first operational mode, with the scheduler circuitry, determining, based on the first operational mode, an order of execution of a third one or more microoperations of the first thread of execution relative to a fourth one or more microoperations of the second thread of execution.

In one or more fourteenth embodiments, further to any of the tenth through thirteenth embodiments, the method further comprises detecting a condition wherein a target of the first one or more microoperations spans multiple lines of a cache, wherein according to the one or more synchronization requirements, the scheduler circuitry is to provide, based on the condition, an indication of a delay to be applied before an execution of the second one or more microoperations, and based on the second mode, the scheduler circuitry foregoes providing the indication of the delay.

In one or more fifteenth embodiments, further to any of the tenth through fourteenth embodiments, the control register is a first control register of a first core of the processor, the synchronization control is a first synchronization control to apply the one or more synchronization requirements at the first core, and a second control register of the processor is to determine an enablement state of a second synchronization control which is to apply the one or more synchronization requirements at a second core of the processor.

In one or more sixteenth embodiments, further to any of the tenth through fifteenth embodiments, an execution of a first instruction by the first thread of execution comprises an execution of a plurality of microoperations which comprise the first one or more microoperations and a third one or more microoperations, according to the one or more synchronization requirements, an execution of the plurality of microoperations is to be performed after a completion of an execution of the second one or more microoperations, and based on the second operational mode, the second one or more microoperations are executed after the first one or more microoperations, and before the third one or more microoperations.

In one or more seventeenth embodiments, further to any of the tenth through sixteenth embodiments, the first thread of execution and the second thread of execution are each based on a single instruction, multiple data (SIMD) instruction.

In one or more eighteenth embodiments, further to any of the tenth through seventeenth embodiments, the first operational mode is a default mode of the scheduler circuitry.

In one or more nineteenth embodiments, a system comprises a memory, a processor coupled to the memory, the processor comprising a control register, first circuitry to execute an instruction of a program, wherein the first circuitry to execute the instruction comprises the first circuitry to perform an access to the control register, wherein the program is to provide a thread group which comprises a first thread of execution and a second thread of execution, and second circuitry coupled to the control register and the first circuitry, the second circuitry to transition, based on the access, between a first operational mode wherein a synchronization control is enabled, wherein the synchronization control is to apply one or more synchronization requirements to threads of execution, and a second operational mode wherein the synchronization control is disabled, and wherein the second circuitry is further to determine, based on one of the first operational mode or the second operational mode, an order of execution of a first one or more microoperations of the first thread of execution relative to a second one or more microoperations of the second thread of execution, and a display device coupled to the processor and the memory, the display device to display an image based on the first thread of execution and the second thread of execution.

In one or more twentieth embodiments, further to the nineteenth embodiment, according to the one or more synchronization requirements, an execution of the first one or more microoperations is to be performed after a completion of an execution of the second one or more microoperations, based on the access, the second circuitry is to transition to the second operational mode, and the second circuitry to determine the order of execution comprises, based on the second operational mode, the second circuitry to prevent a delay to an execution of the first one or more microoperations.

In one or more twenty-first embodiments, further to the nineteenth embodiment or the twentieth embodiment, the first thread of execution is to follow a first path of a branch instruction of the program, the second thread of execution is to follow a second path of the branch instruction, according to the one or more synchronization requirements, an execution of the first one or more microoperations based on the first path is to be performed prior to an execution of the second one or more microoperations based on the second path, based on the access, the second circuitry is to transition to the second operational mode, and the second circuitry to determine the order of execution comprises, based on the second operational mode, the second circuitry to select the second one or more microoperations to be executed prior to an execution of the first one or more microoperations.

In one or more twenty-second embodiments, further to any of the nineteenth through twenty-first embodiments, the instruction is a first instruction, the access is a first access, based on the first access, the second circuitry is to transition to the second operational mode, the first circuitry is further to execute a second instruction of the program, wherein the first circuitry is to perform a second access to the control register, the second circuitry, based on the second access, is to transition from the second operational mode to the first operational mode, and the second circuitry is further to determine, based on the first operational mode, an order of execution of a third one or more microoperations of the first thread of execution relative to a fourth one or more microoperations of the second thread of execution.

In one or more twenty-third embodiments, further to any of the nineteenth through twenty-second embodiments, the second circuitry is further to detect a condition wherein a target of the first one or more microoperations spans multiple lines of a cache, according to the one or more synchronization requirements, the second circuitry is to provide, based on the condition, an indication of a delay to be applied before an execution of the second one or more microoperations, and based on the second mode, the second circuitry is to forego a communication of the indication of the delay.

In one or more twenty-fourth embodiments, further to any of the nineteenth through twenty-third embodiments, the control register is a first control register of a first core of the processor, the synchronization control is a first synchronization control to apply the one or more synchronization requirements at the first core, and the processor further comprises a second control register to determine an enablement state of a second synchronization control which is to apply the one or more synchronization requirements at a second core of the processor.

In one or more twenty-fifth embodiments, further to any of the nineteenth through twenty-fourth embodiments, an execution of a first instruction by the first thread of execution is to comprise an execution of a plurality of microoperations which comprise the first one or more microoperations and a third one or more microoperations, according to the one or more synchronization requirements, an execution of the plurality of microoperations is to be performed after a completion of an execution of the second one or more microoperations, and based on the second operational mode, the second one or more microoperations are to be executed after the first one or more microoperations, and before the third one or more microoperations.

In one or more twenty-sixth embodiments, further to any of the nineteenth through twenty-fifth embodiments, the first thread of execution and the second thread of execution are each to be based on a single instruction, multiple data (SIMD) instruction.

In one or more twenty-seventh embodiments, further to any of the nineteenth through twenty-sixth embodiments, the first operational mode is a default mode of the second circuitry.

In this description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” or other such disjunctive language can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A processor comprising:
a control register;
first circuitry to execute an instruction of a program, wherein the first circuitry to execute the instruction comprises the first circuitry to perform an access to the control register, wherein the program is to provide a thread group which comprises a first thread of execution and a second thread of execution; and
second circuitry coupled to the control register and the first circuitry, the second circuitry to transition, based on the access, between:
a first operational mode wherein a synchronization control is enabled, wherein the synchronization control is to apply one or more synchronization requirements to threads of execution; and
a second operational mode wherein the synchronization control is disabled; and
wherein the second circuitry is further to determine, based on one of the first operational mode or the second operational mode, an order of execution of a first one or more microoperations of the first thread of execution relative to a second one or more microoperations of the second thread of execution.

2. The processor of claim 1, wherein:
according to the one or more synchronization requirements, an execution of the first one or more microoperations is to be performed after a completion of an execution of the second one or more microoperations;
based on the access, the second circuitry is to transition to the second operational mode; and
the second circuitry to determine the order of execution comprises, based on the second operational mode, the second circuitry to prevent a delay to an execution of the first one or more microoperations.

3. The processor of claim 1, wherein:
the first thread of execution is to follow a first path of a branch instruction of the program;
the second thread of execution is to follow a second path of the branch instruction;
according to the one or more synchronization requirements, an execution of the first one or more microoperations based on the first path is to be performed prior to an execution of the second one or more microoperations based on the second path;
based on the access, the second circuitry is to transition to the second operational mode; and
the second circuitry to determine the order of execution comprises, based on the second operational mode, the second circuitry to select the second one or more microoperations to be executed prior to an execution of the first one or more microoperations.

4. The processor of claim 1, wherein:
the instruction is a first instruction;
the access is a first access;
based on the first access, the second circuitry is to transition to the second operational mode;
the first circuitry is further to execute a second instruction of the program, wherein the first circuitry is to perform a second access to the control register;
the second circuitry, based on the second access, is to transition from the second operational mode to the first operational mode; and
the second circuitry is further to determine, based on the first operational mode, an order of execution of a third one or more microoperations of the first thread of execution relative to a fourth one or more microoperations of the second thread of execution.

5. The processor of claim 1, wherein:
the second circuitry is further to detect a condition wherein a target of the first one or more microoperations spans multiple lines of a cache;
according to the one or more synchronization requirements, the second circuitry is to provide, based on the condition, an indication of a delay to be applied before an execution of the second one or more microoperations; and
based on the second mode, the second circuitry is to forego a communication of the indication of the delay.

6. The processor of claim 1, wherein:
the control register is a first control register of a first core of the processor;
the synchronization control is a first synchronization control to apply the one or more synchronization requirements at the first core; and
the processor further comprises a second control register to determine an enablement state of a second synchronization control which is to apply the one or more synchronization requirements at a second core of the processor.

7. The processor of claim 1, wherein:
an execution of a first instruction by the first thread of execution is to comprise an execution of a plurality of microoperations which comprise the first one or more microoperations and a third one or more microoperations;
according to the one or more synchronization requirements, an execution of the plurality of microoperations is to be performed after a completion of an execution of the second one or more microoperations; and
based on the second operational mode, the second one or more microoperations are to be executed after the first one or more microoperations, and before the third one or more microoperations.

8. The processor of claim 1, wherein the first thread of execution and the second thread of execution are each to be based on a single instruction, multiple data (SIMD) instruction.

9. The processor of claim 1, wherein the first operational mode is a default mode of the second circuitry.

10. A method comprising:
executing an instruction of a program by a processor, wherein executing the instruction comprises performing an access to a control register of the processor, wherein the program is to provide a thread group which comprises a first thread of execution and a second thread of execution; and
based on the access, transitioning scheduler circuitry of the processor between:
a first operational mode wherein a synchronization control is enabled, wherein the synchronization control is to apply one or more synchronization requirements to threads of execution; and
a second operational mode wherein the synchronization control is disabled; and
with the scheduler circuitry, determining, based on one of the first operational mode or the second operational mode, an order of execution of a first one or more microoperations of the first thread of execution relative to a second one or more microoperations of the second thread of execution.

11. The method of claim 10, wherein:
according to the one or more synchronization requirements, an execution of the first one or more microoperations is to be performed after a completion of an execution of the second one or more microoperations;
transitioning the scheduler circuitry based on the access comprises transitioning the scheduler circuitry to the second operational mode; and
determining the order of execution comprises, based on the second operational mode, preventing a delay to an execution of the first one or more microoperations.

12. The method of claim 10, wherein:
the first thread of execution is to follow a first path of a branch instruction of the program;
the second thread of execution is to follow a second path of the branch instruction;
according to the one or more synchronization requirements, an execution of the first one or more microoperations based on the first path is to be performed prior to an execution of the second one or more microoperations based on the second path;
transitioning the scheduler circuitry based on the access comprises transitioning the scheduler circuitry to the second operational mode; and
determining the order of execution comprises, based on the second operational mode, selecting the second one or more microoperations to be executed prior to an execution of the first one or more microoperations.

13. The method of claim 10, wherein:
the instruction is a first instruction;
the access is a first access;
transitioning the scheduler circuitry based on the first access comprises transitioning the scheduler circuitry to the second operational mode; and
the method further comprises:
executing a second instruction of the program, wherein executing the second instruction comprises performing a second access to the control register; and
based on the second access, transitioning the scheduler circuitry from the second operational mode to the first operational mode;
with the scheduler circuitry, determining, based on the first operational mode, an order of execution of a third one or more microoperations of the first thread of execution relative to a fourth one or more microoperations of the second thread of execution.

14. The method of claim 10, further comprising detecting a condition wherein a target of the first one or more microoperations spans multiple lines of a cache;
wherein:
according to the one or more synchronization requirements, the scheduler circuitry is to provide, based on the condition, an indication of a delay to be applied before an execution of the second one or more microoperations; and
based on the second mode, the scheduler circuitry foregoes providing the indication of the delay.

15. The method of claim 10, wherein:
the control register is a first control register of a first core of the processor;
the synchronization control is a first synchronization control to apply the one or more synchronization requirements at the first core; and
a second control register of the processor is to determine an enablement state of a second synchronization control which is to apply the one or more synchronization requirements at a second core of the processor.

16. The method of claim 10, wherein:
an execution of a first instruction by the first thread of execution comprises an execution of a plurality of microoperations which comprise the first one or more microoperations and a third one or more microoperations;
according to the one or more synchronization requirements, an execution of the plurality of microoperations is to be performed after a completion of an execution of the second one or more microoperations; and
based on the second operational mode, the second one or more microoperations are executed after the first one or more microoperations, and before the third one or more microoperations.

17. A system comprising:
a memory;
a processor coupled to the memory, the processor comprising:
a control register;
first circuitry to execute an instruction of a program, wherein the first circuitry to execute the instruction comprises the first circuitry to perform an access to the control register, wherein the program is to provide a thread group which comprises a first thread of execution and a second thread of execution; and
second circuitry coupled to the control register and the first circuitry, the second circuitry to transition, based on the access, between:
a first operational mode wherein a synchronization control is enabled, wherein the synchronization control is to apply one or more synchronization requirements to threads of execution; and
a second operational mode wherein the synchronization control is disabled; and
wherein the second circuitry is further to determine, based on one of the first operational mode or the second operational mode, an order of execution of a first one or more microoperations of the first thread of execution relative to a second one or more microoperations of the second thread of execution; and
a display device coupled to the processor and the memory, the display device to display an image based on the first thread of execution and the second thread of execution.

18. The system of claim 17, wherein:
according to the one or more synchronization requirements, an execution of the first one or more microoperations is to be performed after a completion of an execution of the second one or more microoperations;
based on the access, the second circuitry is to transition to the second operational mode; and
the second circuitry to determine the order of execution comprises, based on the second operational mode, the second circuitry to prevent a delay to an execution of the first one or more microoperations.

19. The system of claim 17, wherein:
the first thread of execution is to follow a first path of a branch instruction of the program;
the second thread of execution is to follow a second path of the branch instruction;
according to the one or more synchronization requirements, an execution of the first one or more microoperations based on the first path is to be performed prior to an execution of the second one or more microoperations based on the second path;
based on the access, the second circuitry is to transition to the second operational mode; and
the second circuitry to determine the order of execution comprises, based on the second operational mode, the second circuitry to select the second one or more microoperations to be executed prior to an execution of the first one or more microoperations.

20. The system of claim 17, wherein:
an execution of a first instruction by the first thread of execution is to comprise an execution of a plurality of microoperations which comprise the first one or more microoperations and a third one or more microoperations;
according to the one or more synchronization requirements, an execution of the plurality of microoperations is to be performed after a completion of an execution of the second one or more microoperations; and
based on the second operational mode, the second one or more microoperations are to be executed after the first one or more microoperations, and before the third one or more microoperations.
